(19) United States
(12) Patent Application Publication
(10) Pub. No.: US 2019/0169385 A1
(43) Pub. Date: Jun. 6, 2019

(54) BLOWN FILMS HAVING IMPROVED HAZE, AND ARTICLES MADE THEREFROM

(71) Applicant: Dow Global Technologies LLC, Midland, MI (US)

(72) Inventors: Mustafa Bilgen, Manvel, TX (US); Mehmet Demirors, Pearland, TX (US); Teresa P. Karjala, Lake Jackson, TX (US); Nermeen W. Aboelella, Pearland, TX (US)

(73) Assignee: Dow Global Technologies LLC, Midland, MI (US)

(21) Appl. No.: 16/309,975

(22) PCT Filed: Aug. 4, 2017
(86) PCT No.: PCT/US2017/045430

§ 371 Date: Dec. 14, 2018

Related U.S. Application Data
(60) Provisional application No. 62/373,533, filed on Aug. 11, 2016.

(51) Int. Cl. C08J 5/18; C08F 110/02; C08F 210/16; C08L 23/08; C08L 23/06

(52) U.S. Cl. CPC C08J 5/18; C08F 110/02; C08F 210/16; C08L 23/0815; C08L 23/06; C08F 2/04; C08J 2323/08; C08F 2500/12; C08F 2500/03; C08F 2500/26; C08F 2500/07; C08J 2323/06

(57) ABSTRACT

Disclosed herein is a blown film comprising at least 50 wt. % of a polyethylene composition comprising the reaction product of ethylene and optionally, one or more alpha-olefin comonomers, wherein the polyethylene composition is characterized by the following properties: a melt index, I₂, of from 0.1 to 2 g/10 min; a density of from 0.940 to 0.970 g/cm³; a melt flow ratio, I₁₀/I₂, of from 5.5 to 7.2; and a molecular weight distribution (Mw/Mn) of from 2.2 to 3.5.

### TECHNICAL FIELD

Embodiments of the present disclosure generally relate to blown films and applications of the blown films to make articles, such as, shrink films, flat surface protection films, bags, laminates and laminated pouches. In particular, this disclosure relates to blown films having improved haze and articles thereof.

### BACKGROUND

Polyethylene films are widely used in packaging, such as, for example, shrink films, bag applications, laminates, pouches, and protective films. In some instances, the polyethylene films may have high total haze values, such as, above 30% for a 1 mil monolayer blown film. Such high haze values may limit the ability of those films to be used in clear film applications, such as, bags with see through windows, surface protection films with see through optics, and high optics shrink films.

Accordingly, alternative blown polyethylene films having low haze values while ensuring good modulus properties may be desired.

### SUMMARY

Disclosed in embodiments herein are blown films. In a first embodiment, the blown film comprises at least 50 wt. % of a polyethylene composition comprising the reaction product of ethylene and optionally, one or more alpha-olefin comonomers, wherein the polyethylene composition is characterized by the following properties: a melt index, I₂, of from 0.1 to 2 g/10 min; a density of from 0.940 to 0.970 g/cm³; a melt flow ratio, I₁₀/I₂, of from 5.5 to 7.2; and a molecular weight distribution (Mw/Mn) of from 2.2 to 3.5. The blown films described in one or more embodiments herein may be a monolayer film or form one or more layers of a multilayer film.

In a second embodiment, the polyethylene composition of the first embodiment has a melt index, I₂, of from 0.1 to less than 1 g/10 min In a third embodiment, the polyethylene composition of the second embodiment has a melt index, I₂, of from 0.5 to less than 1.5 g/10 min. In a fourth embodiment, the polyethylene composition of the first or second embodiments has a vinyl unsaturation of greater than 0.12 vinyls per one thousand carbon atoms. In a fifth embodiment, the polyethylene composition of the first through four embodiments is formed in the presence of a catalyst composition comprising a multi-metallic procatalyst via solution polymerization in at least one reactor. In a sixth embodiment, the solution polymerization of the fifth embodiment occurs in a single reactor. In a seventh embodiment, the blown film of embodiments one through six exhibits a total haze value of less than 30% for a 1 mil monolayer blown film.

Additional features and advantages of the embodiments will be set forth in the detailed description which follows, and in part will be readily apparent to those skilled in the art from that description or recognized by practicing the embodiments described herein, including the detailed description which follows, the claims. It is to be understood that both the foregoing and the following description describe various embodiments and are intended to provide an overview or framework for understanding the nature and character of the claimed subject matter. The description serves to explain the principles and operations of the claimed subject matter.

### DETAILED DESCRIPTION

Reference will now be made in detail to embodiments of blown films (hereinafter called “films”), examples of which are further described below. The films may be used to produce shrink films, protective films, bags, laminates, and pouches having an improved total haze value. It is noted, however, that this is merely an illustrative implementation of the embodiments disclosed herein. The embodiments are applicable to other technologies that are susceptible to similar problems as those discussed above. For example, the films may be used to produce oriented films, barrier films, and bags and all are clearly within the purview of the present embodiments. The film may be a monolayer film or form one or more layers of a multilayer film. As used herein, “multilayer film” refers to a film having two or more layers that are at least partially contiguous and preferably, but optionally, coextensive. The film is a blown film.

In embodiments herein, the film comprises at least 50 wt. % of a polyethylene composition. All individual values and subranges are included and disclosed herein. For example, the film may comprise from 50 to 100 percent, 55 to 100 percent, 60 to 100 percent, 65 to 100 percent, 70 to 100 percent, 75 to 100 percent, 80 to 100 percent, 85 to 100 percent, 90 to 100 percent, or 95 to 100 percent, based on the total weight of polymers present in the film, of the polyethylene composition.

The polyethylene composition comprises the reaction product of ethylene and, optionally, one or more alpha-olefin comonomers. The polyethylene composition comprises greater than 50 wt. % of the units derived from ethylene and less than 30 wt. % of the units derived from one or more alpha-olefin comonomers. In some embodiments, the polyethylene composition may be a homopolymer and comprise 100%, by weight, of the units derived from ethylene. In some embodiments, the polyethylene composition comprises (a) greater than or equal to 75%, greater than or equal to 90%, greater than or equal to 95%, greater than or equal to 99%, greater than or equal to 99.5%, by weight, of the units derived from ethylene; and (b) optionally, less than 25 percent, less than 10%, less than 5%, less than 1%, or less than 0.5%, by weight, of units derived from one or more alpha-olefin comonomers. The comonomer content may be measured using any suitable technique, such as techniques based on nuclear magnetic resonance (“NMR”) spectroscopy, and, for example, by 13C NMR analysis as described in U.S. Pat. No. 7,498,282, which is incorporated herein by reference.

Suitable comonomers may include alpha-olefin comonomers, typically having no more than 20 carbon atoms. The one or more alpha-olefins may be selected from the group consisting of C3-C20 acetylenically unsaturated monomers and C4-C18 diolefins. For example, the alpha-olefin comonomers may have 3 to 10 carbon atoms, or 3 to 8 carbon atoms. Exemplary alpha-olefin comonomers include, but are not limited to, propylene, 1-butene, 1-pentene, 1-hexene, 1-heptene, 1-octene, 1-nonene, 1-decene, and 4-methyl-1-pentene. The one or more alpha-olefin comonomers may, for example, be selected from the group consisting of propylene, 1-butene, 1-hexene, and 1-octene; or in the alternative, from the group consisting of 1-butene, 1-hexene and 1-octene.

In the embodiments herein, the polyethylene composition is formed in the presence of a catalyst composition comprising a multi-metallic procatalyst via solution polymerization in at least one reactor. In one or more embodiment, the polyethylene composition is formed in the presence of a catalyst composition comprising a multi-metallic procatalyst comprising of three or more transition metals via solution polymerization in at least one reactor. In some embodiments, the solution polymerization occurs in a single reactor. The multi-metallic procatalyst used in producing the reaction product is at least trimetallic, but may also include more than three transition metals, and thus may be defined more comprehensively as multi-metallic. These three, or more, transition metals are selected prior to production of the catalyst. In a particular embodiment, the multi-metal catalyst comprises titanium as one element.

The catalyst compositions may be prepared beginning first with preparation of a conditioned magnesium halide-based support. Preparation of a conditioned magnesium halide-based support begins with selecting an organomagnesium compound or a complex including an organomagnesium compound. Such compound or complex is desirably soluble in an inert hydrocarbon diluent. The concentrations of components are preferably such that when the active halide, such as a metallic or non-metallic halide, and the magnesium complex are combined, the resultant slurry is from about 0.005 to about 0.25 molar (moles/liter) with respect to magnesium. Examples of suitable inert organic diluents include liquefied ethane, propane, isobutane, n-butane, n-hexane, the various isomeric hexanes, isooctane, paraffinic mixtures of alkanes having from 5 to 10 carbon atoms, cyclohexane, methylcyclopentane, dimethylcyclohexane, dodecane, industrial solvents composed of saturated or aromatic hydrocarbons such as kerosene, naphthas, and combinations thereof, especially when freed of any olefin compounds and other impurities, and especially those having boiling points in the range from about −50° C. to about 200° C. Also included as suitable inert diluents are ethylbenzene, cumene, decalin and combinations thereof.

Suitable organomagnesium compounds and complexes may include, for example, magnesium C2-C8 alkyls and aryls, magnesium alkoxides and aryloxides, carboxylated magnesium alkoxides, and carboxylated magnesium aryloxides. Preferred sources of magnesium moieties may include the magnesium C2-C8 alkyls and C1-C4 alkoxides. Such organomagnesium compound or complex may be reacted with a metallic or non-metallic halide source, such as a chloride, bromide, iodide, or fluoride, in order to make a magnesium halide compound under suitable conditions. Such conditions may include a temperature ranging from −25° C. to 100° C., alternatively, 0° C. to 50° C.; a time ranging from 1 to 12 hours, alternatively, from 4 to 6 hours; or both. The result is a magnesium halide based support.

The magnesium halide support is then reacted with a selected conditioning compound containing an element selected from the group consisting of boron, aluminum, gallium, indium and tellurium, under conditions suitable to form a conditioned magnesium halide support. This compound and the magnesium halide support are then brought into contact under conditions sufficient to result in a conditioned magnesium halide support. Such conditions may include a temperature ranging from 0° C. to 50° C., or alternatively, from 25° C. to 35° C.; a time ranging from 4 to 24 hours, or alternatively, from 6 to 12 hours; or both. The conditioning compound has a molar ratio constitution that is specific and which is believed to be an important feature in ensuring the desirable catalyst performance Specifically, the procatalyst desirably exhibits a molar ratio of the magnesium to the conditioning compound that ranges from 3:1 to 6:1. Without wishing to be bound by any theory of mechanism, it is suggested that this aging serves to facilitate or enhance adsorption of additional metals onto the support.

Once the conditioned support is prepared and suitably aged, it is brought into contact with a titanium compound which may be added individually or as a mixture with the “second metal”. In certain preferred embodiments titanium halides or alkoxides, or combinations thereof, may be selected. Conditions may include a temperature within the range from 0° C. to 50° C., alternatively from 25° C. to 35° C.; a time from 3 hours to 24 hours, alternatively from 6 hours to 12 hours; or both. The result of this step is adsorption of at least a portion of the titanium compound onto the conditioned magnesium halide support.

Finally, one or two additional metals, referred to herein as “the second metal” and “the third metal” for convenience, will also be adsorbed onto the magnesium-based support, The “second metal” and the “third metal” are independently selected from zirconium (Zr), hafnium (Hf), vanadium (V), niobium (Nb), tantalum (Ta), chromium (Cr), molybdenum (Mo), and tungsten (W). These metals may be incorporated in any of a variety of ways known to those skilled in the art, but generally contact between the conditioned magnesium based halide support including titanium and the selected second and third metals, in, e.g., liquid phase such as an appropriate hydrocarbon solvent, will be suitable to ensure deposition of the additional metals to form what may now be referred to as the “procatalyst,” which is a multi-metallic procatalyst.

The multi-metallic procatalyst has a molar ratio constitution that is specific and which is believed to be an important feature in ensuring the desirable polymer properties that may be attributed to the catalyst made from the procatalyst. Specifically, the procatalyst desirably exhibits a molar ratio of the magnesium to a combination of the titanium and the second and third metals that ranges from 30:1 to 5:1; under conditions sufficient to form a multi-metallic procatalyst. Thus, the overall molar ratio of magnesium to titanium ranges from 8:1 to 80:1. In some embodiments, the Al:Ti ratio is from 6 to 15, 7 to 14, 7 to 13, 8 to 13, 9 to 13, or 9 to 12.

Once the procatalyst has been formed, it may be used to form a final catalyst by combining it with a cocatalyst consisting of at least one organometallic compound such as an alkyl or haloalkyl of aluminum, an alkylaluminum halide, a Grignard reagent, an alkali metal aluminum hydride, an alkali metal borohydride, an alkali metal hydride, an alkaline earth metal hydride, or the like. The formation of the final catalyst from the reaction of the procatalyst and the organometallic cocatalyst may be carried out in situ, or just prior to entering the polymerization reactor. Thus, the combination of the cocatalyst and the procatalyst may occur under a wide variety of conditions. Such conditions may include, for example, contacting them under an inert atmosphere such as nitrogen, argon or other inert gas at temperatures in the range from 0° C. to 250° C., preferably from 15° C. to 200° C. In the preparation of the catalytic reaction product, it is not necessary to separate hydrocarbon soluble components from hydrocarbon insoluble components. Time for contact between the procatalyst and cocatalyst may desirably range, for example, from 0 to 240 seconds, preferably from 5 to 120 seconds. Various combinations of these conditions may be employed.

In embodiments described herein, the polyethylene composition may have a metal catalyst residual of greater than or equal to 1 parts by combined weight of at least three metal residues per one million parts of polyethylene polymer, wherein the at least three metal residues are selected from the group consisting of titanium, zirconium, hafnium, vanadium, niobium, tantalum, chromium, molybdenum, tungsten, and combinations thereof, and wherein each of the at least three metal residues is present at greater than or equal to 0.2 ppm, for example, in the range of from 0.2 to 5 ppm. All individual values and subranges from greater than or equal to 0.2 ppm are included herein and disclosed herein; for example, the polyethylene composition may further comprise greater than or equal to 2 parts by combined weight of at least three metal residues remaining from the multi-metallic polymerization catalyst per one million parts of the polyethylene composition.

In some embodiments, the polyethylene composition comprises at least 0.75 ppm of V (Vanadium). All individual values and subranges from at least 0.75 ppm of V are included and disclosed herein; for example the lower limit of the V in the polyethylene composition may be 0.75, 1, 1.1, 1.2, 1.3 or 1.4 ppm to an upper limit of the V in the polyethylene composition may be 5, 4, 3, 2, 1.9, 1.8, 1.7, 1.6, 1.5, or 1 ppm. The vanadium catalyst metal residual concentration for the polyethylene composition can be measured using the Neutron Activation Method for Metals described below.

In some embodiments, the polyethylene composition comprises at least 0.3 ppm of Zr (Zirconium). All individual values and subranges of at least 0.3 ppm of Zr are included and disclosed herein; for example the lower limit of the Zr in the polyethylene composition may be 0.3, 0.4, 0.5, 0.6 or 0.7 ppm. In yet another embodiment, the upper limit of the Zr in the polyethylene composition may be 5, 4, 3, 2, 1, 0.9, 0.8 or 0.7 ppm. The zirconium catalyst metal residual concentration for the polyethylene composition can be measured using the Neutron Activation Method for Metals described below.

In one or more embodiments described herein, the polyethylene composition has a density of 0.940 g/cm³ to 0.970 g/cm³. All individual values and subranges of at least 0.940 g/cm³ to 0.970 g/cm³ are included and disclosed herein. For example, in some embodiments, the polyethylene composition may have a density ranging from a lower limit of 0.940, 0.942, 0.945, 0.946, or 0.947 g/cm³ to an upper limit of 0.970, 0.968, 0.967, 0.965, 0.963, or 0.962 g/cm³. In other embodiments, the polyethylene composition may have a density of 0.940 to 0.970 g/cm³, 0.942 to 0.967 g/cm³, 0.942 to 0.965 g/cm³, 0.945 to 0.965 g/cm³, or 0.945 to 0.963 g/cm³. In further embodiments, the polyethylene composition may have a density of from 0.945 to 0.970 g/cm³, 0.947 to 0.970 g/cm³, 0.950 to 0.970 g/cm³, 0.9520 to 0.970 g/cm³, 0.952 to 0.968 g/cm³, 0.9550 to 0.970 g/cm³, or 0.955 to 0.965 g/cm³. Density may be measured in accordance with ASTM D792.

In addition to the density, the polyethylene composition has a melt index, I₂, of 0.1 g/10 min to 2 g/10 min. All individual values and subranges of 0.1 g/10 min to 2 g/10 min are included and disclosed herein. For example, in some embodiments, the polyethylene composition may have melt index, I₂, ranging from a lower limit of 0.1, 0.2, 0.3, 0.4, 0.5, 0.6, 0.7, 0.8, or 0.9 to an upper limit of 2, 1.9, 1.8, 1.7, 1.6, 1.5, 1.4, 1.3, 1.2, 1.1, 1.0, or 0.9 g/10 min. In other embodiments, the polyethylene composition may have a melt index, I₂, of 0.1 g/10 min to 1.0 g/10 min. In further embodiments, the polyethylene composition may have a melt index, I₂, of 0.1 g/10 min to less than 1.0 g/10 min. Melt index, I₂, may be measured in accordance with ASTM D1238 (190° C. and 2.16 kg).

In addition to the density and melt index, 1₂, the polyethylene composition has a melt flow ratio, I₁₀/I₂, of from 5.5 to 7.2. All individual values and subranges of from 5.5 to 7.2 are included and disclosed herein. For example, in some embodiments, the polyethylene composition may have a melt flow ratio, I₁₀/I₂, ranging from a lower limit of 5.5, 5.6, 5.7, 5.8, 5.9, 6.0, 6.1, 6.2, 6.3, 6.4, or 6.5 to an upper limit of 7.2, 7.0, 6.8, or 6.7. In other embodiments, the polyethylene composition may have a melt flow ratio, I₁₀/O₂, of from 5.6 to 7.0, 5.8 to 7.0, or 6.0 to 6.8. Melt index, I₁₀, may be measured in accordance with ASTM D1238 (190° C. and 10.0 kg).

In addition to the density, melt index, I₂, and melt flow ratio, I₁₀/I₂, the polyethylene composition has a molecular weight distribution (Mw/Mn) of from 2.2 to 3.5. All individual values and subranges of from 2.2 to 3.5 are included and disclosed herein. For example, the polyethylene composition may have an Mw/Mn ratio from a lower limit of 2.2, 2.3, 2.4, 2.5, 2.6, 2.7, or 2.8 to an upper limit of 3.5, 3.4, 3.3, 3.2, 3.1, 3.0, or 2.9. In some embodiments, the polyethylene composition may have an Mw/Mn ratio of from 2.2 to 3.5, 2.3 to 3.5, 2.4 to 3.5, 2.4 to 3.2, 2.5 to 3.2, or 2.6 to 3.1. In other embodiments, the polyethylene composition may have an Mw/Mn ratio of from 2.3 to 3.0, 2.4 to 3.0, 2.5 to 3.0, 2.6 to 3.0, or 2.7 to 3.0. Molecular weight distribution can be described as the ratio of weight average molecular weight (M_{w}) to number average molecular weight (Mₙ) (i.e., M_{w} /Mₙ), and can be measured by gel permeation chromatography techniques.

In addition to the density, melt index, I₂, melt flow ratio, I₁₀/I₂, and molecular weight distribution (Mw/Mn), the polyethylene composition may have a vinyl unsaturation of greater than 0.12 vinyls per one thousand carbon atoms (“1000C”). All individual values and subranges from greater than 0.12 vinyls per 1000 carbon atoms are included and disclosed herein. In some embodiments, the polyethylene composition may have greater than or equal to 0.13, 0.14, 0.15, or 0.16 vinyls per 1000 carbon atoms. In other embodiments, the polyethylene composition may have vinyls per 1000 carbon atoms ranging from a lower limit of greater than 0.12, 0.13, 0.14, 0.15, 0.16, or 0.17 to an upper limit of 0.50, 0.45, 0.40, 0.35, 0.30, 0.26, 0.25, 0.24, 0.23, 0.22, 0.21, or 0.20. In further embodiments, the polyethylene composition may have greater than 0.12 to 0.50, 0.13 to 0.45, 0.14 to 0.40, 0.14 to 0.35, 0.14 to 0.30, 0.14 to 0.25, or 0.15 to 0.22 vinyls per 1000 carbon atoms.

In one or more embodiments herein, the films described herein may further comprise one or more additional polymers, such as polypropylene, propylene-based plastomers or elastomers, ethylene/vinyl alcohol (EVOH) copolymers, polyvinylidene chloride (PVDC), polyethylene terepthalate (PET), oriented polypropylene (OPP), ethylene/vinyl acetate (EVA) copolymers, ethylene/acrylic acid (EAA) copolymers, ethylene/methacrylic acid (EMAA) copolymers, polyacrylic imides, butyl acrylates, peroxides (such as peroxypolymers, e.g., peroxyolefins), silanes (e.g., epoxysilanes), reactive polystyrenes, chlorinated polyethylene, olefin block copolymers, propylene copolymers, propylene-ethylene copolymers, ULDPE, LLDPE, HDPE, MDPE, LMDPE, LDPE, ionomers, and graft-modified polymers (e.g., maleic anhydride grafted polyethylene). The one or more additional polymers may be present in an amount of less than 30 wt. %, less than 25 wt. %, less than 20 wt. %, less than 15 wt. %, less than 12 wt. %, less than 10 wt. %, less than 8 wt. %, less than 5 wt. %, less than 3 wt. %, less than 2 wt. %, less than 1 wt. %,or less than 0.5 wt. %, based on the total weight of polymers present in the film.

The films described herein may be made via any number of processes. Exemplary processes may include making the film into a blown film, where the polymer is dropped into the hopper of an extruder for making the blown film. The blown film line may be equipped with an annular die having a specific diameter and a die gap. The blow up ratio (BUR) may be adjusted by inflating the bubble that is coming out of the annular die. Cooling may be applied from outside the bubble as well as inside the bubble to solidify the molten polymer. The solidified film may be collapsed by collapsing frames and flattened by nip rolls. The flat film is later wound onto a roll for further processing.

In some embodiments, the film may form one or more layers of a multilayer film. In a multilayer blown film process, the polymer is dropped into the hopper of one of the extruders for making the blown film. There may be two to eleven or more extruders. In coextruded films, multiple extruders feed a multilayer annular die. The individual feed lines or extruders feed molten polymer at a specific rate into the die. All of the layers may be combined inside the die and exit as a multilayer structure. The blown film line may be equipped with an annular die having a specific diameter and a die gap. The blow up ratio (BUR) may be adjusted by inflating the bubble that is coming out of the annular die. Cooling may be applied from outside the bubble as well as inside the bubble to solidify the molten polymer. The solidified film may be collapsed by collapsing frames and flattened by nip rolls. The flat film is later wound onto a roll for further processing.

In one or more embodiments herein, the film may have a thickness of between about 0.1-10 mils. All individual values and subranges from 0.1-10 mils are included and disclosed herein. For example, in some embodiments, the film may have a thickness of between about 0.3-5 mils or 0.5-3 mils. In other embodiments, the film may have a thickness of between about 0.7-2 mils. In further embodiments, the film may have a thickness of between about 0.9-1.5 mils.

In one or more embodiments herein, the film exhibits a total haze value of less than 30% for a 1 mil monolayer blown film. All individual values and subranges from less than 30% for a 1 mil monolayer blown film are included and disclosed herein. For example, in some embodiments, the film exhibits a total haze value of less than 25% for a 1 mil monolayer blown film.

In one or more embodiments herein, the film may comprise one or more additives. Additives may include, but are not limited to, antioxidants (e.g., hindered phenolics, such as, IRGANOX® 1010 or IRGANOX® 1076, supplied by Ciba Geigy), phosphites (e.g., IRGAFOS® 168, also supplied by Ciba Geigy), cling additives (e.g., PIB (polyisobutylene)), Standostab PEPQ™ (supplied by Sandoz), pigments, colorants, TiO₂, anti-stat additives, flame retardants, slip agents, antiblock additives, biocides, antimicrobial agents, and clarifiers/nucleators (e.g., HYPERFORM™ HPN-20E, MILLAD™ 3988, MILLAD™ NX 8000, available from Milliken Chemical). The additives can be included in the film at levels typically used in the art to achieve their desired purpose. In some examples, the one or more additives are included in amounts ranging from 0-10%, based on total polymer weight of the film, 0-5%, based on total polymer weight of the film, 0.001-5%, based on total polymer weight of the film, 0.001-3%, based on total polymer weight of the film, 0.005-2%, based on total polymer weight of the film, or 0.005-1%, based on total polymer weight of the film.

### Test Methods

Density

Samples for density measurements were prepared according to ASTM D 4703-10 Annex A1 Procedure C. Approximately 7 g of sample was placed in a “2″×2″×135 mil thick” mold, and this was pressed at 374° F. (190° C.) for six minutes at 3,000 lb_{f}(0.0133 MN). Then the pressure was increased to 30,000 lb_{f} (0.133 MN) for four minutes. This was followed by cooling at 15° C. per minute, at 30,000 lb_{f} (0.133 MN), to approximately a temperature of 40° C. The “2″×2″×135 mil” polymer sample (plaque) was then removed from the mold, and three samples were cut from the plaque with a ½″×1″ die cutter. Density measurements were made within one hour of sample pressing, using ASTM D792-08, Method B. Density was reported as an average of three measurements.
Melt Index

Melt index (I₂) can be measured in accordance with ASTM D-1238, Procedure B (condition 190° C./2.16 kg). Melt index (I₁₀) can be measured in accordance with ASTM D-1238, Procedure B (condition 190° C./10.0 kg).
Gel Permeation Chromatography (GPC)

The chromatographic system consisted of a PolymerChar GPC-IR (Valencia, Spain) high temperature GPC chromatograph equipped with an internal IRS detector. The autosampler oven compartment was set at 160° Celsius and the column compartment was set at 150° Celsius. The columns used were 3 Agilent “Mixed B” 30 cm 10-micron linear mixed-bed columns and a 10-μm pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)).:

M_{polyethylene}=A×(M_{polystyrene})^{B} (EQ1)

where M is the molecular weight, A has a value of 0.4315 and B is equal to 1.0.

A fifth order polynomial was used to fit the respective polyethylene-equivalent calibration points. A small adjustment to A (from approximately 0.415 to 0.44) was made to correct for column resolution and band-broadening effects such that NIST standard NBS 1475 is obtained at 52,000 g/mol Mw.

The total plate count of the GPC column set was performed with Eicosane (prepared at 0.04 g in 50 milliliters of TCB and dissolved for 20 minutes with gentle agitation.) The plate count (Equation 2) and symmetry (Equation 3) was measured on a 200 microliter injection according to the following equations:

$$Plate Count = 5.54 * ( \frac{{RV}_{Peak Max}}{Peak Width at \frac{1}{2} height} ) \qquad ( EQ 2 )$$

where RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - {RV}_{Peak max} )}{( {RV}_{Peak max} - Front Peak {RV}_{one tenth height} )} \qquad ( EQ 3 )$$

where RV is the retention volume in milliliters and the peak width is in milliliters, peak max is the maximum position of the peak, one tenth height is 1/10 height of the peak maximum, rear peak refers to the peak tail at later retention volumes than the peak max, and front peak refers to the peak front at earlier retention volumes than the peak max. The plate count for the chromatographic system should be greater than 24,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200ppm BHT) was added to a pre nitrogen-sparged septa-capped vial, via the PolymerChar high temperature autosampler. The samples were dissolved for 2 hours at 160° Celsius under “low speed” shaking.

The calculations of Mn, Mw, and Mz were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$$\begin{matrix}Mn = \frac{{\sum }^{i} {IR}_{i}}{{\sum }^{i} ( {IR}_{i} / {M}_{{polyethylene}_{i}} )} & ( EQ 4 ) \\ Mw = \frac{{\sum }^{i} ( {IR}_{i} * {M}_{{polyethylene}_{i}} )}{{\sum }^{i} {IR}_{i}} & ( EQ 5 ) \\ Mz = \frac{{\sum }^{i} ( {IR}_{i} * {M}_{{polyethylene}_{i}}^{2} )}{{\sum }^{i} ( {IR}_{i} / {M}_{{polyethylene}_{i}} )} & ( EQ 6 )\end{matrix}$$

In order to monitor the deviations over time, a flowrate marker (decane) was introduced into each sample via a micropump controlled with the PolymerChar GPC-IR system. This flowrate marker was used to linearly correct the flowrate for each sample by alignment of the respective decane peak within the sample to that of the decane peak within the narrow standards calibration. Any changes in the time of the decane marker peak are then assumed to be related to a linear shift in both flowrate and chromatographic slope. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (as a measurement of the calibration slope) is calculated as Equation 7. Processing of the flow marker peak was done via the PolymerChar GPCOne™ Software.

$${Flowrate}_{effective} = {Flowrate}_{nominal} \times \frac{{FlowMarker}_{Calibration}}{{FlowMarker}_{Observed}} \qquad ( EQ 7 )$$

Neutron Activation Method for Metals

Two sets of duplicate samples were prepared by transferring approximately 3.5 grams of the pellets into pre-cleaned 2 dram polyethylene vials. Standards were prepared for each metal tested from their NIST traceable standard solutions (Certi. pure from SPEX) into 2-dram polyethylene vials. They were diluted using milli-Q pure water to 6 ml and the vials were heat-sealed. The samples and standards were then analyzed for these elements, using a Mark I TRIGA nuclear reactor. The reactions and experimental conditions used for these elements are summarized in the table below. The samples were transferred to un-irradiated vials before doing the gamma-spectroscopy. The elemental concentrations were calculated using CANBERRA software and standard comparative technique. Table 1 provides measurement parameters for metals determination.

TABLE 1
Reactions and experimental conditions used for
elements during the neutron activation method

| | Nuclear | | | | Reactor |
|---|---|---|---|---|---|
| Elements | reaction | Isotope | Half life | | Power |
| Al | ²⁷Al(n,γ)²⁸Al | ²⁸Al | 2.24 | m | 250 kW |
| Cl | ³⁷Cl(n,γ)³⁸Cl | ³⁸Cl | 37.2 | m | 250 kW |
| Cr | ⁵⁰Cr(n,γ)⁵¹Cr | ⁵¹Cr | 27.7 | d | 250 kW |
| Hf | ¹⁸⁰Hf(n,γ)¹⁸¹Hf | ¹⁸¹Hf | 42.4 | d | 250 kW |
| Mg | ²⁶Mg(n,γ)²⁷Mg | ²⁷Mg | 9.46 | m | 250 kW |
| Mo | ⁹⁸Mo(n,γ)⁹⁹Mo | ⁹⁹Mo | 66.0 | h | 250 kW |
| Nb | ⁹³Nb(n,γ)^{94m}Nb | ^{94m}Nb | 6.26 | m | 250 kW |
| Ta | ¹⁸¹Ta(n,γ)¹⁸²Ta | ¹⁸²Ta | 114.4 | d | 250 kW |
| Ti | ⁵⁰Ti(n,γ)⁵¹Ti | ⁵¹Ti | 5.76 | m | 250 kW |
| W | ¹⁸⁶W(n,γ)¹⁸⁷W | ¹⁸⁷W | 23.7 | h | 250 kW |
| V | ⁵¹V(n,γ)⁵²V | ⁵²V | 3.75 | m | 250 kW |
| Zr | ⁹⁶Zr(n,γ)⁹⁷Zr | ⁹⁷Zr | 16.91 | h | 250 kW |

TABLE 1
Continued

| | Irradiation | | Waiting | | Counting | | Gamma |
|---|---|---|---|---|---|---|---|
| Elements | Time | | Time | | Time | | Energy, keV |
| Al | 2 | m | 4 | m | 4.5 | min | 1778.5 |
| Cl | 2 | m | 4 | m | 4.5 | min | 1642.5, 2166.5 |
| Cr | 90 | m | 5 | h | 1.6 | h | 320 |
| Hf | 90 | m | 5 | h | 1.6 | h | 133, 482 |
| Mg | 2 | m | 4 | m | 4.5 | min | 843.8, 1014 |
| Mo | 90 | m | 5 | h | 1.6 | h | 181,739.7, 141 |
| Nb | 2 | m | 4 | m | 4.5 | min | 871 |
| Ta | 90 | m | 5 | h | 1.6 | h | 1121, 1222 |
| Ti | 2 | m | 4 | m | 4.5 | min | 320 |
| W | 90 | m | 5 | h | 1.6 | h | 135, 481 |
| V | 2 | m | 4 | m | 4.5 | min | 1434 |
| Zr | 90 | m | 5 | h | 1.6 | h | 743.4 |

Differential Scanning calorimetry (DSC)

DSC was used to measure the melting and crystallization behavior of a polymer over a wide range of temperatures. For example, the TA Instruments Q1000 DSC, equipped with an RCS (refrigerated cooling system) and an autosampler was used to perform this analysis. During testing, a nitrogen purge gas flow of 50 ml/min was used. Each sample was melt pressed into a thin film at about 175° C.; the melted sample was then air-cooled to room temperature (approx. 25° C.). The film sample was formed by pressing a “0.1 to 0.2 gram” sample at 175° C. at 1,500 psi, and 30 seconds, to form a “0.1 to 0.2 mil thick” film. A 3-10 mg, 6 mm diameter specimen was extracted from the cooled polymer, weighed, placed in a light aluminum pan (ca 50 mg), and crimped shut. Analysis was then performed to determine its thermal properties.

The thermal behavior of the sample was determined by ramping the sample temperature up and down to create a heat flow versus temperature profile. First, the sample was rapidly heated to 180° C., and held isothermal for five minutes, in order to remove its thermal history. Next, the sample was cooled to −40° C., at a 10° C./minute cooling rate, and held isothermal at −40° C. for five minutes. The sample was then heated to 150° C. (this is the “second heat” ramp) at a 10° C./minute heating rate. The cooling and second heating curves were recorded. The cool curve was analyzed by setting baseline endpoints from the beginning of crystallization to -20° C. The heat curve was analyzed by setting baseline endpoints from −20° C. to the end of melt. The values determined were peak melting temperature, which were reported from the second heat curve.
Nuclear Magnetic Resonance ¹H NMR)

The samples were prepared by adding approximately 130 mg of sample to “3.25 g of 50/50, by weight, tetrachlorethane-d₂/perchloroethylene (TCE-d₂)” with 0.001 M Cr(AcAc)₃ in a NORELL 1001-7, 10 mm NMR tube. The samples were purged by bubbling N₂ through the solvent, via a pipette inserted into the tube, for approximately five minutes, to prevent oxidation. Each tube was capped, sealed with TEFLON tape, and then soaked at room temperature, overnight, to facilitate sample dissolution. The samples were heated and vortexed at 115° C. to ensure homogeneity.

The ¹H NMR was performed on a Bruker AVANCE 400 MHz spectrometer, equipped with a Bruker Dual DUL high-temperature CryoProbe, and a sample temperature of 120° C. Two experiments were run to obtain spectra, a control spectrum to quantitate the total polymer protons, and a double presaturation experiment, which suppressed the intense polymer backbone peaks, and enabled high sensitivity spectra for quantitation of the end-groups. The control was run with ZG pulse, 16 scans, AQ 1.64 s, D1 14 s. The double presaturation experiment was run with a modified pulse sequence, 100 scans, AQ 1.64 s, presaturation delay ls, relaxation delay 13 s.

The signal from residual ¹H in TCE-d₂ (at 6.0 ppm) was integrated, and set to a value of 100, and the integral from 3 to −0.5 ppm was used as the signal from the whole polymer in the control experiment. For the presaturation experiment, the TCE signal was also set to 100, and the corresponding integrals for unsaturation (vinylene at about 5.25 to 5.60 ppm, trisubstituted at about 5.16 to 5.25 ppm, vinyl at about 4.95 to 5.15 ppm, and vinylidene at about 4.70 to 4.90 ppm) were obtained.

In the presaturation experiment spectrum, the regions for cis- and trans-vinylene, trisubstituted, vinyl, and vinylidene were integrated. The integral of the whole polymer from the control experiment was divided by two to obtain a value representing X thousands of carbons (i.e., if the polymer integral=28000, this represents 14,000 carbons, and X=14).

The unsaturated group integrals, divided by the corresponding number of protons contributing to that integral, represent the moles of each type of unsaturation per X thousand carbons. Dividing the moles of each type of unsaturation by X, then gives moles unsaturated groups per 1000 moles of carbons.

### Film Property Test Methods

Film Gloss at 45°

Film Gloss at 45° is measured according to ASTM 2457-08 (average of five film samples; each sample “10 in×10 in”).
Total Haze

Total haze of a film is measured according to ASTM D1003-07. For each test, five samples were examined, and an average reported. Sample dimensions were “6 in×6 in.”

### Clarity

Clarity was measured according to ASTM D1746-09 (average of five film samples; each sample “10 in×10 in”).

### EXAMPLES

A multi-metal catalyst is prepared (Catalyst 1) and a non-multi-metal catalyst is prepared (Catalyst A). Catalyst 1 is then used to prepare an inventive polyethylene composition in a solution polymerization. Catalyst A is used to prepare a comparative polyethylene composition. Subsequently, the inventive and comparative polyethylene compositions are used to prepare inventive and comparative blown films, respectively. Testing is carried out on both the polyethylene compositions and the blown films.

### General Description of Preparation of Catalysts

The catalyst compositions may be prepared beginning first with preparation of a conditioned magnesium halide based support. Preparation of a conditioned magnesium halide based support begins with selecting an organomagnesium compound or a complex including an organomagnesium compound. Such compound or complex is desirably soluble in an inert hydrocarbon diluent. In one embodiment, the concentrations of components are such that when the active halide, such as a metallic or non-metallic halide, and the magnesium complex are combined, the resultant slurry is from about 0.005 to about 0.3 molar (moles/liter) with respect to magnesium. Examples of suitable inert organic diluents include liquefied ethane, propane, isobutane, n-butane, n-hexane, the various isomeric hexanes, isooctane, paraffinic mixtures of alkanes having from 5 to 10 carbon atoms, cyclohexane, methylcyclopentane, dimethylcyclohexane, dodecane, industrial solvents composed of saturated or aromatic hydrocarbons such as kerosene, naphthas, and combinations thereof, especially when freed of any olefin compounds and other impurities, and especially those having boiling points in the range from about −50 ° C. to about 200 ° C. Also included as suitable inert diluents are ethylbenzene, cumene, decalin and combinations thereof.

Suitable organomagnesium compounds and complexes may include, for example, magnesium C2-C8 alkyls and aryls, magnesium alkoxides and aryloxides, carboxylated magnesium alkoxides, and carboxylated magnesium aryloxides. Preferred sources of magnesium moieties may include the magnesium C2-C8 alkyls and C1-C4 alkoxides. Such organomagnesium compound or complex may be reacted with a metallic or non-metallic halide source, such as a chloride, bromide, iodide, or fluoride, in order to make a magnesium halide compound under suitable conditions. Such conditions may include a temperature ranging from −25° C. to 100° C., or alternatively, 0° C. to 50° C.; a time ranging from 1 to 12 hours, or alternatively, from 4 to 6 hours; or both. The result is a magnesium halide-based support.

The magnesium halide support is then reacted with a selected conditioning compound containing an element selected from the group consisting of boron, aluminum, gallium, indium and tellurium, under conditions suitable to form a conditioned magnesium halide support. This compound and the magnesium halide support are then brought into contact under conditions sufficient to result in a conditioned magnesium halide support. Such conditions may include a temperature ranging from 0° C. to 50° C., or alternatively, from 25° C. to 35° C.; a time ranging from 4 to 24 hours, or alternatively, from 6 to 12 hours; or both. Without wishing to be bound by any theory of mechanism, it is suggested that this aging serves to facilitate or enhance adsorption of additional metals onto the support.

Once the conditioned support is prepared and suitably aged, it is brought into contact with a titanium compound. In certain preferred embodiments, titanium halides or alkoxides, or combinations thereof, may be selected. Conditions may include a temperature within the range from 0° C. to 50° C., or alternatively, from 25° C. to 35° C.; a time from 3 hours to 24 hours, or alternatively, from 6 hours to 12 hours; or both. The result of this step is adsorption of at least a portion of the titanium compound onto the conditioned magnesium halide support.

Additional Steps in Preparing Multi-Metal Catalyst used to make the Inventive Polyethylene Composition

For those catalysts used to make the inventive polyethylene composition, i.e. multi-metal catalysts herein, two additional metals, referred to herein as “the second metal” and “the third metal” for convenience, will also be adsorbed onto the magnesium based support, The “second metal” and the “third metal” are independently selected from zirconium (Zr), hafnium (Hf), vanadium (V), niobium (Nb), tantalum (Ta), chromium (Cr), molybdenum (Mo), and tungsten (W). These metals may be incorporated in any of a variety of ways known to those skilled in the art, but generally contact between the conditioned magnesium based halide support including titanium and the selected second and third metals, in, e.g., liquid phase such as an appropriate hydrocarbon solvent, will be suitable to ensure deposition of the additional metals to form what may now be referred to as the “procatalyst,” which is a multi-metallic procatalyst.

In certain embodiments, the multi-metal procatalyst exhibits a molar ratio of the magnesium to a combination of the titanium and the second and third metals that ranges from 30:1 to 5:1; under conditions sufficient to form a multi-metallic procatalyst. Thus, the overall molar ratio of magnesium to titanium ranges from 8:1 to 80:1.

Once the procatalyst has been formed, it may be used to form a final catalyst by combining it with a cocatalyst consisting of at least one organometallic compound such as an alkyl or haloalkyl of aluminum, an alkylaluminum halide, a Grignard reagent, an alkali metal aluminum hydride, an alkali metal borohydride, an alkali metal hydride, an alkaline earth metal hydride, or the like. The formation of the final catalyst from the reaction of the procatalyst and the organometallic cocatalyst may be carried out in situ, or just prior to entering the polymerization reactor. Thus, the combination of the cocatalyst and the procatalyst may occur under a wide variety of conditions. Such conditions may include, for example, contacting them under an inert atmosphere such as nitrogen, argon or other inert gas at temperatures in the range from 0° C. to 250° C., or alternatively, from 15° C. to 200° C. In the preparation of the catalytic reaction product, it is not necessary to separate hydrocarbon soluble components from hydrocarbon insoluble components. Time for contact between the procatalyst and cocatalyst may range, for example, from 0 to 240 seconds, or alternatively, from 5 to 120 seconds. Various combinations of these conditions may be employed.
Catalyst A Preparation

To 800 mL of MgCl₂ (0.20 M in ISOPAR™ E) is added (C₂H₅)AlCl₂ (EADC) (48 mL of a 1.0 M solution in hexane). The resulting mixture is allowed to stir overnight at room temperature. A solution of Ti(OiPr)₄ (titanium isopropoxide, 48 mL of a 0.25 M solution in ISOPAR™ E) is then added to the magnesium/aluminum suspension. The resulting mixture is allowed to stir overnight to complete the procatalyst aging.
Catalyst I Preparation

To approximately 109 kg of 0.20 M MgCl₂ slurry was added 7.76 kg of (C₂H₅)AlC2 (EADC) solution (15 wt. % in heptanes), followed by agitation for 8 hours. A mixture of TiCl₄/VOCl₃ (85 mL and 146 mL, respectively) was then added, followed by a solution of Zr(TMHD)₄ (Zirconium tetrakis(2,2,6,6-tetramethyl-3,5-heptanedionate) (0.320 kg of a 0.30 M solution in Isopar E). These two additions were performed sequentially within 1 hour of each other. The resulting catalyst premix was aged with agitation for an additional 8 h prior to use.

Each of the catalysts prepared hereinabove is then used to prepare Polyethylene Compositions as described below.

### Production of Inventive Polyethylene Composition and Comparative Polyethylene Composition Example B

The polyethylene resins are produced via a solution polymerization according to the following exemplary process. All raw materials (monomer) and the process solvent (a narrow boiling range high-purity isoparaffinic solvent, Isopar-E) are purified with molecular sieves before introduction into the reaction environment. Hydrogen is supplied in pressurized cylinders as a high purity grade and is not further purified. The reactor monomer feed stream is pressurized via a mechanical compressor to above reaction pressure. The solvent feed is pressurized via a pump to above reaction pressure. The individual catalyst components are manually batch diluted to specified component concentrations with purified solvent and pressured to above reaction pressure. All reaction feed flows are measured with mass flow meters and independently controlled with computer automated valve control systems.

The continuous solution polymerization reactor consists of a liquid full, non-adiabatic, isothermal, circulating, loop reactor which mimics a continuously stirred tank reactor (CSTR) with heat removal. Independent control of all fresh solvent, monomer, hydrogen, and catalyst component feeds is possible. The total fresh feed stream to the reactor (solvent, monomer, and hydrogen) is temperature controlled by passing the feed stream through a heat exchanger. The catalyst components are injected into the polymerization reactor through a specially designed injection stinger and are combined into one mixed catalyst/cocatalyst feed stream prior to injection into the reactor. The primary catalyst component feed is computer controlled to maintain the reactor monomer concentration at a specified target. The cocatalyst component is fed based on calculated specified molar ratios to the primary catalyst component Immediately following each fresh injection location (either feed or catalyst), the feed streams are mixed with the circulating polymerization reactor contents with static mixing elements. The contents of the reactor are continuously circulated through heat exchangers responsible for removing much of the heat of reaction and with the temperature of the coolant side responsible for maintaining an isothermal reaction environment at the specified temperature. Circulation around the reactor loop is provided by a positive displacement pump.

The final reactor effluent enters a zone where it is deactivated with the addition of and reaction with water. At this same reactor exit location other additives may also be added (such as an acid scavenging agent and anti-oxidants). The stream then goes through a static mixer to disperse the post reactor additive components.

Following catalyst deactivation and additive addition, the reactor effluent enters a devolatization system where the polymer is removed from the non-polymer stream. The isolated polymer melt is pelletized and collected. The non-polymer stream passes through various pieces of equipment which separate most of the ethylene which is removed from the system. Most of the solvent and unreacted monomer is recycled back to the reactor after passing through a purification system. A small amount of solvent and monomer is purged from the process.

Table 2 summarizes the polymerization conditions for the Inventive Polyethylene Composition (IE) and Comparative Polyethylene Composition B (Comp. B). Additives used in these polymerizations were 1000 ppm IRGAFOS™ 168 (which is tris (2,4 di-tert-butylphenyl) phosphite), 250 ppm IRGANOX™ 1076 (which is octadecyl-3-(3,5-di-tert-butyl-4-hydroxyphenyl)propionate)), and 200 ppm IRGANOX™ 1010 (tetrakis(methylene(3,5-di-tert-butyl-4-hydroxyhydrocinnamate))methane). IRGAFOS™ 168 and IRGANOX™ 1076 are commercially available from BASF. IRGANOX™ 1010 is available from BASF. Comparative Polyethylene Composition A (Comp. A) is ELITE™ 5960G, available from The Dow Chemical Company. Comparative Polyethylene Composition C (Comp. C) is DGDA 5004 NT, available from The Dow Chemical Company. Comparative Polyethylene Composition D (Comp. D) is HDPE 6410, available from Total S.A.

TABLE 2
Polymerization Conditions

| Sample | | IE | Comp B |
|---|---|---|---|
| Reactor Configuration | Type | Single | Single |
| Comonomer type | Type | none | none |
| Reactor Feed Solvent/Ethylene | g/g | 4.0 | 3.7 |
| Mass Flow Ratio | | | |
| Reactor Feed Comonomer/Ethylene | g/g | 0 | 0 |
| Mass Flow Ratio | | | |
| Reactor Feed Hydrogen/Ethylene | g/g | 9.8E−05 | 1.2E−04 |
| Mass Flow Ratio | | | |
| Reactor Temperature | ° C. | 190 | 195 |
| Reactor Pressure | barg | 50 | 50 |
| Reactor Ethylene Conversion | % | 93.0 | 92.9 |
| Reactor Catalyst Type | Type | Catalyst-1 | Catalyst-A |
| Reactor Co-Catalyst Type | Type | TEA* | TEA* |
| Reactor Co-Catalyst to Catalyst | Ratio | 12.0 | 4.0 |
| Molar Ratio (Al to Ti ratio) | | | |
| Reactor Residence Time | Min | 5.4 | 6.3 |

*TEA is tri-ethyl-aluminum.

TABLE 3
Resin Melt Index and Density Data

| | I₂, g/ | | Density |
|---|---|---|---|
| Sample | 10 min | I₁₀/I₂ | (g/cm³) |
| IE | 0.96 | 6.67 | 0.958 |
| Comp. A | 0.85 | 11.0 | 0.962 |
| Comp. B | 1.0 | 7.5 | 0.959 |
| Comp. C | 0.8 | 15.4 | 0.963 |
| Comp. D | 1.2 | 8.31 | 0.961 |

TABLE 4
Conventional GPC Data

| | Mn | Mw | Mz | | | |
|---|---|---|---|---|---|---|
| Type | (g/mol) | (g/mol) | (g/mol) | Mw/Mn | Mz/Mw | Mz/Mn |
| IE | 41,449 | 120,838 | 325,384 | 2.92 | 2.69 | 7.85 |
| Comp. A | 20,012 | 105,866 | 290,854 | 5.29 | 2.75 | 14.53 |
| Comp. B | 36,325 | 132,836 | 395,977 | 3.66 | 2.98 | 10.90 |
| Comp. C | 13,334 | 126,560 | 948,297 | 9.49 | 7.49 | 71.12 |
| Comp. D | 19,221 | 115,737 | 395,656 | 6.02 | 3.42 | 20.58 |

TABLE 5
DSC Data

| | Tₘ₁ | Heat of Fusion | % | T_{c1} |
|---|---|---|---|---|
| Type | (° C.) | (J/g) | Crystallinity | (° C.) |
| IE | 134.8 | 216.9 | 74.3 | 120.1 |
| Comp. A | 133.3 | 218.2 | 74.7 | 119.1 |
| Comp. B | 134.9 | 223.5 | 76.5 | 119.9 |
| Comp. C | 133.9 | 228.9 | 78.4 | 120.0 |
| Comp. D | 135.0 | 223.6 | 76.6 | 120.5 |

TABLE 6
Neutron Activation Data*

| | Al, | Mg, | Ti, | V, | Hf, | Zr, | Cl, |
|---|---|---|---|---|---|---|---|
| Type | ppm | ppm | ppm | ppm | ppb | ppm | ppm |
| IE | 6.5 | 14 | 0.60 | 1.45 | ND | 0.840 | 49 |

*Niobium (Nb) (5 ppm), tantalum (Ta) (50 ppb), chromium (Cr) (0.5 ppm), molybdenum (Mo) (50 ppb), and tungsten (W) (5 ppm) were not detected in any of the examples at their respective detection limits, as indicated in the parentheses following each element.
ND = not detected.

TABLE 7
1H NMR Data. Unsaturation Unit/1,000,000 C.

| | | Trisub- | | | Total |
|---|---|---|---|---|---|
| Type | Vinylene | stitued | Vinyl | Vinylidene | Unsaturation |
| IE | 5 | ND | 208 | 2 | 216 |
| Comp. A | 20 | 5 | 168 | 1 | 194 |
| Comp. B | 6 | 3 | 252 | 2 | 263 |
| Comp. C | 22 | 9 | 913 | 13 | 957 |
| Comp. D | 3 | ND | 131 | 1 | 135 |

Film properties
Blown Film Trial I

As shown in Table 8 below, a target gauge of 1 mil monolayer films were fabricated from the resins using a monoextruder blown film line. The IE resin was used to form Film 1. The Comp A resin was used to form Film A. The blown film line was equipped with an annular die having a diameter of 8 inches and a die gap of 70 mils. The blow up ratio (BUR) is 2.5:1. Output rate is 260 lbs/hr. The melt temperature is between 429 and 450° F. The film properties are shown in Table 9.

TABLE 8
Blown Film Trial 1 Process Conditions

| | Actual | | | Die | Target | Melt |
|---|---|---|---|---|---|---|
| | Rate | | Die | Gap | Gauge | Temp |
| Description | lbs/hr | BUR | in | mil | mil | ° F. |
| Film 1 | 261 | 2.5 to 1 | 8 | 70 | 1 | 450 |
| Film A | 259 | 2.5 to 1 | 8 | 70 | 1 | 429 |

TABLE 9
Blown Film Trial 1 Properties

| | Units | Film 1 | Film A |
|---|---|---|---|
| Thickness | mil | 1.02 | 1.16 |
| Clarity | % | 98 | 85 |
| 45° Gloss | | 44 | 15 |
| Total Haze | % | 17 | 41 |

Blown Film Trial 2

As shown in Table 10 below, a target gauge of 1 mil monolayer films were fabricated from the resins using a monoextruder blown film line. The Comp A resin was used to form Film A2. The Comp B resin was used to form Film B. The Comp C resin was used to form Film C. The Comp D resin was used to form Film D. The blown film line was equipped with an annular die having a diameter of 8 inches and a die gap of 90 mils. The blow up ratio (BUR) is 2.5:1. Output rate is 260 lbs/hr. The melt temperature is between 434 and 458° F. The film properties are shown in Table 11.

TABLE 10
Blown Film Trial 2 Process Conditions

| | Actual | | | Die | Target | Melt |
|---|---|---|---|---|---|---|
| | Rate | | Die | Gap | Gauge | Temp |
| Description | lbs/hr | BUR | in | mil | mil | ° F. |
| Film A | 265 | 2.5 to 1 | 8 | 90 | 1 | 458 |
| Film B | 262 | 2.5 to 1 | 8 | 90 | 1 | 457 |
| Film C | 263 | 2.5 to 1 | 8 | 90 | 1 | 434 |
| Film D | 259 | 2.5 to 1 | 8 | 90 | 1 | 447 |

TABLE 11
Blown Film Trial 2 Properties

| | Units | Film A2 | Film B | Film C | Film D |
|---|---|---|---|---|---|
| Thickness | mil | 0.92 | 0.94 | 1.19 | 0.91 |
| Clarity | % | 75 | 92 | 59 | 97 |
| 45° Gloss | | 11 | 20 | 19 | 30 |
| Total Haze | % | 54 | 35 | 41 | 25 |

As shown in Table 9, the inventive film achieves a total haze much lower than 30% and still has good gloss and clarity, while comparative film A has a much higher total haze value.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A blown film comprising at least 50 wt. % of a polyethylene composition comprising the reaction product of ethylene and optionally, one or more alpha-olefin comonomers, wherein the polyethylene composition is characterized by the following properties:
a. a melt index, I₂, of from 0.1 to 2 g/10 min;
b. a density of from 0.940 to 0.970 g/cm³;
c. a melt flow ratio, I₁₀/I₂, of from 5.5 to 7.2; and
d. a molecular weight distribution (MWD) of from 2.2 to 3.5.

2. The blown film of claim 1, wherein the polyethylene composition has a vinyl unsaturation of greater than 0.12 vinyls per one thousand carbon atoms.

3. The blown film of claim 1 wherein the polyethylene composition has a melt index, I₂, of from 0.1 to less than 1 g/10 min

4. The blown film of claim 1, wherein the polyethylene composition has a melt index, I₂, of from 0.5 to less than 1.5 g/10 min.

5. The blown film of claim 1, wherein the polyethylene composition is formed in the presence of a catalyst composition comprising a multi-metallic procatalyst via solution polymerization in at least one reactor.

6. The blown film of claim 5, wherein the solution polymerization occurs in a single reactor.

7. The blown film of claim 1, wherein the blown film exhibits a total haze value of less than 30% for a 1 mil monolayer blown film.

8. The blown film of claim 1, wherein the blown film is a monolayer film.

9. The blown film of claim 1, wherein the blown film forms one or more layers of a multilayer film.
